(19) United States
(12) Patent Application Publication
(10) Pub. No.: US 2007/0044667 A1
(43) Pub. Date: Mar. 1, 2007

(54) Contained flame heating system and method for maintaining chafing dishes and the like heated for prolonged periods

(75) Inventors: Naftali Steinmetz, Brooklyn, NY (US); Sol Basch, Brooklyn, NY (US)

Correspondence Address: OSTROLENK FABER GERB & SOFFEN, 1180 AVENUE OF THE AMERICAS, NEW YORK, NY, 100368403, US

(73) Assignee: SAFlame Product Corp.

(21) Appl. No.: 11/510,362

(22) Filed: Aug. 24, 2006

Related U.S. Application Data
(60) Provisional application No. 60/711,706, filed on Aug. 26, 2005.
(60) Provisional application No. 60/736,800, filed on Nov. 15, 2005.

(51) Int. Cl. A23C 15/04

(52) U.S. Cl. 99/483

(57) ABSTRACT

A heating system for warming food. The system comprises a food tray, a housing and a heating element disposed in the housing. The grill keeps a flame produced by the heating source inside the housing. A grill is disposed above the heating element and connected to the housing. A gas source is connected to the heating element and may be disposed in the housing or external to the housing and connected to the heat source through a cable. A support is effective to support the food tray above the heating element. The food tray may include a divider which defines a space below where food is to be placed. The space may be used to hold a heat core or a heat conductive substance. The heating source may be a catalytic pad. The housing may define a plurality of channels, each holding a respective hearing element.

### CROSS-REFERENCE TO RELATED APPLICATIONS

This patent application claims priority to U.S. Provisional Patent Application No. 60/711,706, filed Aug. 26, 2005 entitled FLAME-LESS HEATING SYSTEM AND METHOD FOR MAINTAINING CHAFING DISHES AND THE LIKE HEATED FOR PROLONGED PERIODS and U.S. Provisional Patent Application 60/736,800 filed Nov. 15, 2005, entitled CONTAINED FLAME HEATING SYSTEM AND METHOD FOR MAINTAINING CHAFING DISHES AND THE LIKE HEATED FOR PROLONGED PERIODS. This application is related to U.S. patent application Ser. No. 10/972,861, filed Oct. 25, 2004 entitled APPARATUS AND METHOD FOR PRESENTING, SERVING AND PROTECTING FOOD AND BEVERAGES, which claims priority to U.S. Provisional Patent Application Ser. No. 60/519,848, filed Nov. 13, 2003 entitled APPARATUS AND METHOD FOR PRESENTING, SERVING, AND PROTECTING FOOD AND BEVERAGES and to U.S. Provisional Patent Application Ser. No. 60/547,654, filed Feb. 25, 2004 entitled APPARATUS AND METHOD FOR PRESENTING, SERVING, AND PROTECTING FOOD AND BEVERAGES. The entire disclosures of all of the above applications are incorporated by reference herein.

### FIELD OF THE INVENTION

This invention, in general, relates to an apparatus and methods for use in serving food products and, in particular, to a portable apparatus and methods for use in the catering industry and home for presenting and serving food products while conserving their state of preparation.

### BACKGROUND OF THE INVENTION

In the catering industry and households, food products are commonly prepared in locations distant from where they are ultimately served. In catering, food preparation takes place at a caterer's base facility and then is transported in a more or less controlled environment to the locations where it is served. Likewise, in the home or catering environment, preparation takes place in the kitchen and then the food is transported elsewhere, such as an outside picnic area, patio, or backyard, and it is desired to maintain the food's temperature over prolonged periods of several hours.

For storing and presenting hot food, it is typical to use a chafing dish system heated from underneath by a heat source such as an open-flame receptacle of STERNO® or a specially configured electric resistance heater. In either case, it is desirable that the heat source provide a substantially uninterrupted heat supply for at least several hours at a time. Because such apparatus is often meant to be mobile and used for presentation in special venues, such as catered outdoor events, requiring a sufficient electric source to be available for heating purposes is inconvenient and undesirable. Moreover, exposed open flames pose safety hazards in addition to violating ordinances in many locales. Consequently, there is a need in the art to provide a convenient non-electric and non-flame producing heat source for storing and presenting hot food.

### SUMMARY OF THE PREFERRED EMBODIMENTS OF THE INVENTION

One embodiment of the invention is a heating system for warming food. The system comprises a food tray, a catalytic pad including a housing and a grill, the grill effective to keep a source of heat or a flame, if any, produced by the catalytic pad inside the housing. The system further includes a gas source connected to the catalytic pad and a support effective to support the food tray above the catalytic pad.

Another embodiment of the invention is a heating system for warming food. The system comprises a food tray, a housing and a heating element disposed in the housing. The system further includes a grill disposed above the heating element, the grill effective to keep a flame produced by the heating element inside the housing. The system further includes a gas source connected to the heating element and disposed in the housing; and a support effective to support the food tray above the heating element.

Yet another embodiment of the invention is a heating system for warming food. The system comprises a food tray, the food tray including a housing and a divider, the divider defining a first space where food may be placed and a second space at a bottom portion of the housing beneath the first space. The system further includes a heating element and a support effective to support the food tray above the heating element.

Still yet another embodiment of the invention is a heating system for warming food. The system comprises a food tray and a housing defining at least two channels. The system further includes a respective heating element disposed in each of the channels and a grill disposed above the heating elements and connected to the housing, the grill effective to keep any flame produced by the heating elements inside the housing. The system further includes a support effective to support the food tray above the housing.

### BRIEF DESCRIPTION OF THE DRAWINGS

The structure, operation, and methodology of the invention, together with other objects and advantages thereof, may best be understood by reading the detailed description in connection with the drawings in which each part has an assigned either a label and/or numeral that identifies it wherever it appears in the various drawings and wherein:

FIG. 1 is a diagrammatic perspective view showing a prior art catering industry chafing dish system with which embodiments of the invention may be used.

FIG. 2 is a diagrammatic exploded perspective view showing various components of the standard catering industry chafing dish system of FIG. 1.

FIG. 3 is a perspective of a heating system for a chafing dish in accordance with an embodiment of the invention.

FIG. 4 shows interchangeable heating elements in accordance with an embodiment of the invention.

FIG. 5 is a side view of a heating system in accordance with an embodiment of the invention.

FIG. 6 is a perspective view showing further details of the control housing for the heating system in accordance with an embodiment of the invention.

FIG. 7 shows further details of the control housing of FIG. 5.

FIG. 8 is a perspective view of an alternate embodiment of a heating system in accordance with an embodiment of the invention.

FIG. 9 is a perspective showing yet another embodiment of the invention.

FIG. 10 is a side cut-away view of a food tray in accordance with an embodiment of the invention.

### DETAILED DESCRIPTION OF PREFERRED EMBODIMENTS

In one aspect of the invention, a gas fueled catalytic heater is provided as a heating source for maintaining hot food. The catalytic heater can generate sufficient heat for maintaining hot food without requiring an electrical supply and without producing a flame. The heater comes in various embodiments that are conveniently adapted for commonly available serving chafing dish systems. In several embodiments, the housing fits around and under a chafing dish shelf designed for common STERNO® cans, including those used with traditional roll-top style cover designs. The protective housing includes a receptacle for attaching portable and reusable pressurized gas containers (i.e. propane or butane tanks), a preferable electric ignition feature, and a knob for adjusting gas flow. The protective housings can be made to incorporate thermally insulating barriers to prevent external non-heating elements from overheating and causing subsequent accidental injury. Several other embodiments incorporate their own covering mechanisms to replace traditional roll-top and other common styles, improving efficiency in design and use and enhancing protection from food contamination.

In another aspect of the invention, the heating system for the chafing dishes includes two main components including a heating element provided in its own portable housing shaped and sized to fit on a chafing dish shelf designed for holding STERNO® cans, or similar shelves. The second main component is in the form of a housing which holds the controls and the fuel supply, which may be one or more propane or butane gas canisters, about two or three inches in diameter and about 8-10 inches in height. A flexible cable extends between the heater housing and the controller housing to carry the gas and the electrical signals for igniting and controlling the level of heat and the turning on and off functions.

In accordance with a further aspect of the invention, the housing contains a specially configured gas burner with an upper grill spaced from a gas burner element so that no flame is visible, and the flame is confined below the upper grill. The flame size and its location in the housing do not allow a flame to appear at the grill, while the flame is controlled to maintain the temperature at the grill surface to produce sufficient heat for the food.

Preferably, the gas conduit and the electrical lines connecting the two major housings are detachably attached to these housings and the control housing is provided with a holding structure that allows it to be supported either below the table holding the chafing dish or to be attached to the chafing dish side frame.

In accordance with yet a further aspect of the invention, the housing contains a plurality of, for example, four, spaced channels that are each formed to contain a STERNO® or other flame source. A hingably connected grill portion is preferably included that is operable to cover the channels, and further that can be locked into place.

In general, the invention relates to portable tray apparatus and methods for displaying and serving warm and hot food products over prolonged periods.

In one aspect of the invention, catalytic or gas burner heating systems are configured and arranged to provide non-electric, non-open flame heat sources for use with chafing dish systems widely used in the catering industry as well as fully integrated stand alone heating systems that can maintain the heat of conventional chafing dish systems directly.

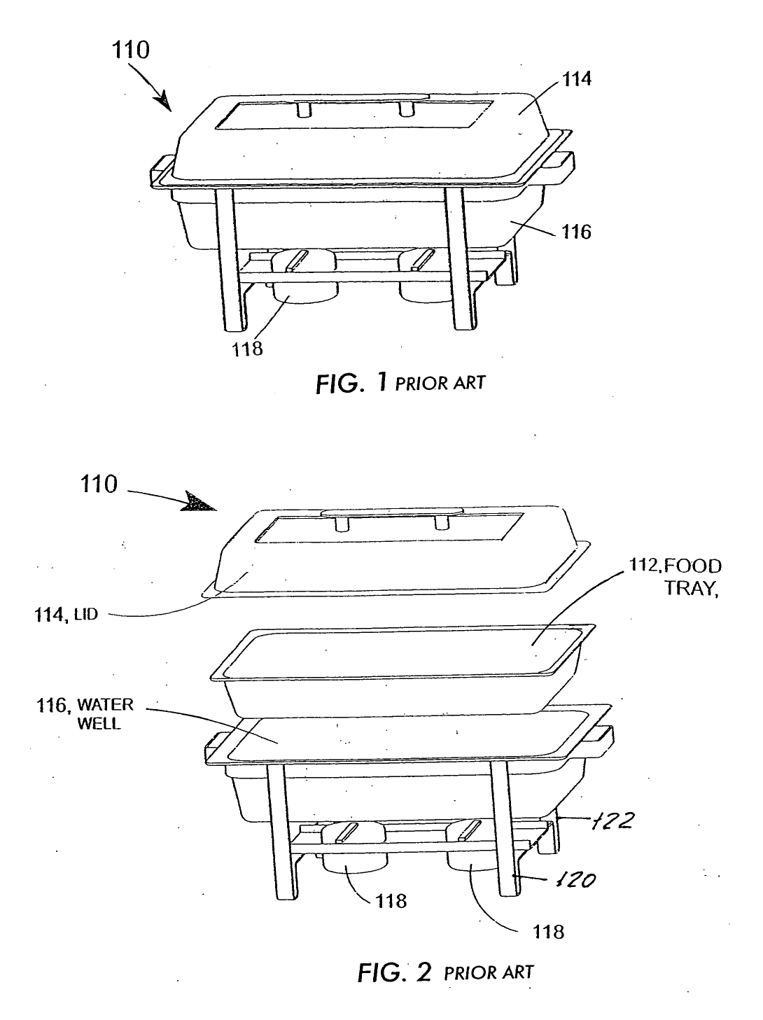

Referring to the drawings, FIG. 1 shows a chafing dish heating system 110 with open flame STERNO® burners 118, serving as the heat source as is known in the prior art. As shown in the exploded view of FIG. 2, chafing dish system 110 stands on legs 120 which support a frame 122 that defines and supports a water well 116 in which a food tray 112 is receivable with the food tray being covered by a lid 114. The STERNO® burners 118 operate with an open flame which heats water in the well to thereby maintain food in the food tray at an even temperature over an extended time period of several hours.

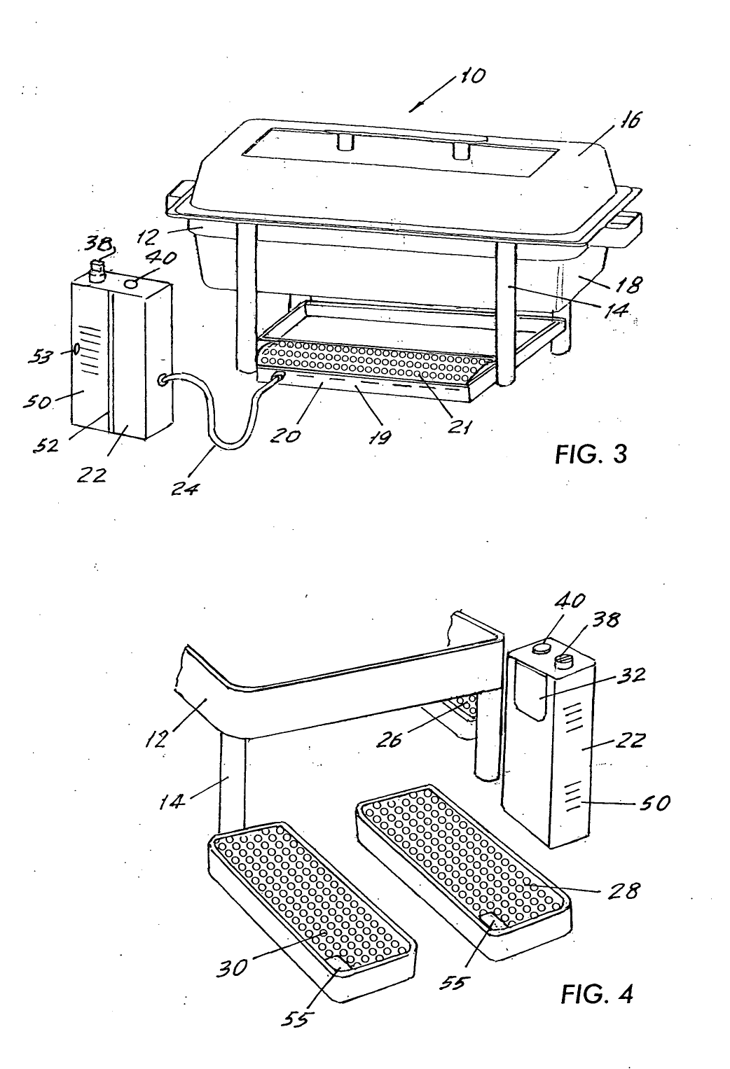

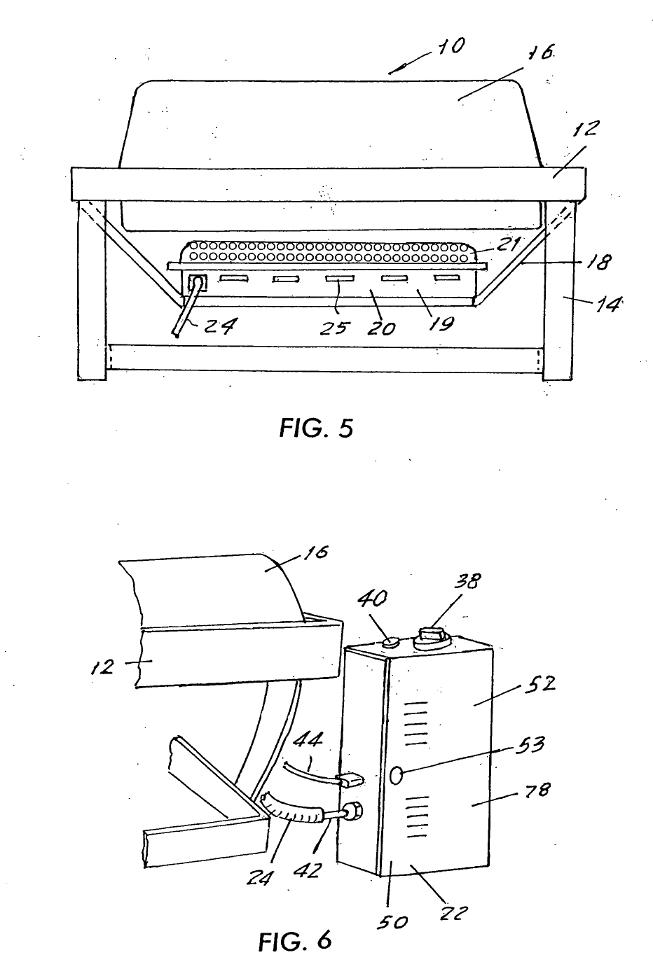

Referring to FIG. 3, a heating system 10 of the present invention comprises a chafing dish frame 12 which is supported on legs 14 and which has a heating element support 18 (FIG. 5) below a food tray and covered by a cover 16. A movable, i.e., portable, heating element 20 includes a grill 23 and is connected by a cable 24 to a controller and fuel supply housing 22.

A gas supply (not shown) powers internal burners below the grill 21 which produce a flame that remains well below the surface of grill 21, so that no open flame is available at the grill 21. The temperature at the grill is just sufficient to maintain the food dish at the proper temperature without producing an open flame. The conduit or cable 24 between the control housing 22 and the heater 20 carries a gas fuel and guide electrical conductors that deliver a spark that lights the gas that is supplied to the burners within the heater 20. Heating element 20 may be a catalytic pad. As shown in FIG. 4, the same control housing 22 can be utilized with a catalytic converter heater 28 of one size, or of another larger size 30, as shown.

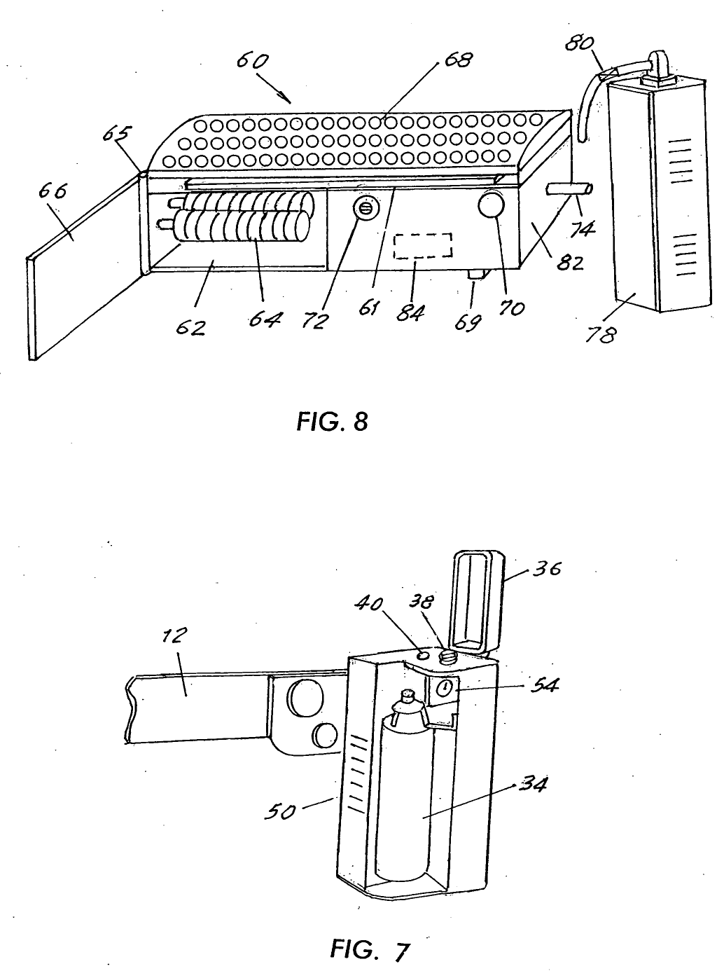

FIGS. 4, 6 and 7 show additional details of control housing 22. Control housing 22 has various perforations 50 that vent its interior space. The interior includes a canister 34 holding a gas such as butane or propane. Housing 22 can be supported by a clip 32 which can be slipped on the side frame 12. The cable 24 is comprised of flexible outer sheet and includes a first conduit 42 for gas and a second conduit 44 for electrical power and spark signals. First and second controls 38 and 40 can be utilized to initially ignite the fuel in the heater 20 and to control its level and rate of heating. A cover or a lid 36 (FIG. 7) protects the controls from tampering, for example, by mischievous children at a catering hall. Lid 36 can be produced so that it locks and can only be opened with a key or the like.

A tray or frame 18 (shown most clearly in FIG. 5) that holds heater 20 can be flat and serve to actuate a switch button 69 (FIG. 8) on the heater element 20. In this way, if heater element 20 is removed from the tray, a fuel supply to heater 20 is automatically interrupted. This structure prevents accidents in case heater 20 falls off or is accidentally pushed off its support surface under frame 12. As shown in FIG. 5, heater 20 may contain various vents 19 and 25 for the flame within. The grill 21 can be perforated with round holes or slots or the like. Tray 18 may be elevated and allow for various height adjustments of heater 20, relative to the underside of water well 116.

FIG. 6 shows that control housing 22 has a portion which serves as a door 50 which is anchored at a flange 52 and which can be opened in order to replace a butane or propane fuel canister, and may have a lock 53. Various valves and other ignition controls are shown at 54 (FIG. 7).

The invention includes the concept of providing a fuel supply that is housed in rectangular or square cans or a housing that can hold two or more standard butane canisters. By housing several such canisters, the invention increases the time period over which food can be maintained at a proper temperature. An indication 55 may be provided at heater 20 which is responsive to heat by changing color or by issuing an alarm to indicate that the heat is not maintained within a proper temperature range.

Referring to FIG. 8, there is shown another embodiment of the invention. As shown, a single housing heating system 60 comprises an upper grill 68 which covers a heating element 61. The heating element 61 may be a catalytic converter or a gas burner. Heating system 60 includes an integrated bottom portion 82 which defines an interior space 62 that houses one or more removable gas canisters 64. Interior space 62 may be made accessible via one or more doors 66 that are hinged at a hinge 65. Controls 70 and 72 can be utilized to control the flow of gas to the heating element 61 below the grill 68 and to initially ignite or start the heating element. A cut-off switch 69 disposed on a bottom of system 60 assures that the system will provide gas fuel or be capable of igniting a flame or start a catalytic converter only when the entire heater housing 60 is resting solidly on a flat surface. If the housing 60 it is lifted (via handles, not shown) or falls off the flat surface, the cut-off switch 69 actuates the heater to turn off.

Bottom portion 82 may include an input gas conduit 74, through which the canisters 64 or an interior gas holding chamber 84 within bottom portion 82 can be recharged with gas from a portable gas tank 78. Gas tank 78 comprises a hose with a valve control 80. In this manner, the heating unit 60 can be fully charged up with gas fuel before a function begins and recharged and reused, from a large central gas source 78 or a pressurized gas supply.

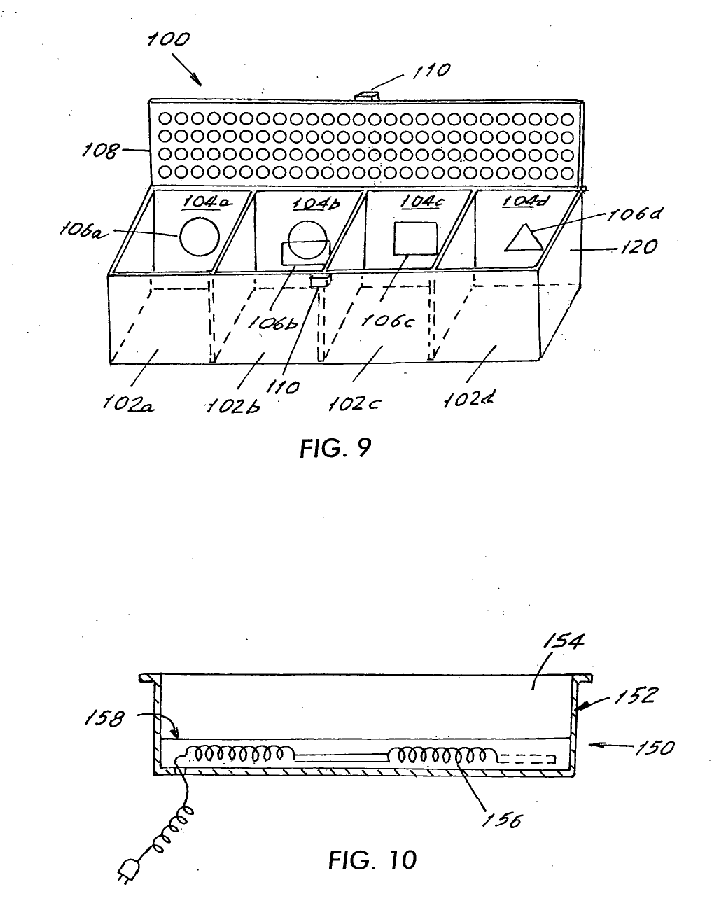

Referring to FIG. 9, an alternative heating arrangement 100 in accordance with an embodiment of the invention is shown. Heating arrangement 100 is preferably used in conjunction with a chafing dish system. In the example in FIG. 9, a heating arrangement includes four individual channels 102a, 102b, 102c and 102d, each of which is sized to contain an individual STERNO® containers. Each respective channel may include a respective channel cover (104a, 104b, 104c, 104d) which, in turn, may have one or more respectively sized and shaped apertures 106 (106a, 106b, 106c, 106d). For example, the apertures may be shaped as a circle, square, triangle, diamond or other shape, and a combination of various shapes may be provided in a single heating arrangement 100. The apertures 106 enable manipulation of a flame emerging from a STERNO® container. Alternatively, a single channel cover 104 is provided over all the channels 102. In yet another arrangement, heating arrangement 100 may be provided without a channel cover.

Heating arrangement 100 preferably includes an upper grill 108 which is hingeably coupled to a body 120 of heating arrangement 100. By providing upper grill 108, flames that emerge from the STERNO® containers are preferably not exposed (or minimally exposed), thereby reducing or eliminating the possibility of a hazardous condition, such as described above.

Thus, the present invention, such as the embodiment illustrated in FIG. 9, provides an alternative to prior art chafing dishes having exposed open flames that pose safety hazards. The heating arrangement 100 is preferably designed and shaped to be received in a chafing dish frame. Unlike prior art chafing systems, the heating arrangement 100 is easier to handle and is conveniently received by a chafing dish frame. By employing several STERNO® containers, such as four in the example shown in FIG. 9, the present invention provides an improved distribution of heat than the typical prior art chafing dish that contains two STERNO® containers. Of course, one skilled in the art will recognize that more or fewer STERNO® containers can be employed by the present invention without departing from the teachings herein. Furthermore, one skilled in the art will recognize that an alternative heat source can be included in heating arrangement 100 besides STERNO® containers. Other flame sources may be included in heating arrangement 100. By providing four (or more) sources of heat, the heating arrangement 100 of the present invention can support, in each channel 102, a smaller STERNO® can than provided in prior art chafing dish systems, which typically require two larger sized cans. Moreover, the size of each flame emitting from channels 102 can similarly be smaller than the size of the flame required in prior art chafing dishes. Instead of a five or six inch tall can of STERNO®, the present invention can make use of a two to three inch can thereby providing a smaller burning flame, without sacrificing the total British thermal units (“BTUs”) provided by the heating arrangement 100. This is accomplished by distributing more smaller flames (e.g., four) over a same general area than fewer larger flames (e.g., two) typical of prior art chafing dish systems.

Moreover, by providing a smaller heating, for example, STERNO®, source, the overall height of heating arrangement 100 is less than the heating source of the prior art chafing dish. This enables a lower height profile and a more efficient and better utilization of space. Further, by providing smaller sized flames in individual channels 102, a smaller gap is required between the upper grill 108 and the top of channels 102.

Further, heating arrangement 100 includes lock 110 that enables the upper grill 108 to be fixed closed, thereby preventing the STERNO® cans from being knocked out of channels 102 in the event of an accident or other disruption.

Therefore, the present invention improves the efficiency (i.e., better distribution of heat and better utilization of space), ease of use (i.e., smaller and contained units) and safety of a portable food warming apparatus.

Referring to FIG. 10, there is shown a side cut-away view of a food tray 150 which could be used as a substitute or in conjunction with any of the above described embodiments. Food tray 150 includes a housing 152 defining an open internal area 154. Area 154 may be used to hold food to be heated by any of the described heating systems. Food tray 150 further includes a divider 158 which defines a space 156 at the bottom of food tray 150. Space 156 may be filled with air or contain a heat conducting liquid or solid, preferably oil. Space 156 thus eliminates the need for a separate water tray as heating incident upon space 156 will be spread across all of food tray 150 and uniformly heat food disposed therein. Divider 158 may comprise or support a removable lining made of, for example, aluminum. The use of such a lining eliminates the need for an extra water tray. Moreover, such a lining helps ensure that food in food tray 150 does not stick to the walls of housing 152. Space 156 may also be used to hold a heating core. The heating core may be powered by a high or low voltage and/or through the use of a portable power source such as a battery or generator. Alternatively, a conventional food tray might be placed within the tray 154, serving solely as a food warmer.

As described above, the invention includes heating a chafing dish, with or without a water pan, using a catalytic pad as the heating unit. The heating unit has been described as comprising either two physical units connected via a hose and cable (one unit having the fuel source and the other constituting the actual heating element), or as a one physical unit, in which the fuel and the heating elements are in the same enclosure.

The invention further comprises providing an enclosed flame burner, either butane, propane, a sterno gel or any other heating source. The heating unit produces its heat output from a single fuel source or a combination of fuel sources and can be contained in either two physical units connected via a hose and cable (with one unit having the fuel source and the other constituting a heating element), or as a one physical unit, in which the fuel and the heating elements are in the same enclosure. In general, as referred herein, including in the claims, a heating unit includes not only the described embodiments thereof, e.g., catalytic, gas burner, sterno fueled sources, etc., but also other known heating items or units such as those known as ceramic burners and the like. The heating units herein are characterized in that they do not use open flames and in that they are portable in the sense that they constitute stand alone units.

The invention has also been described to include the use of throwaway fuel canisters or canisters that can be refilled on site. As described, the chafing dish operates with a low flame or no flame, with either embodiment spreading heat under the chafing dish, enabling direct heat to be conducted to the food dish which, in turn, avoids requiring the use of a water pan. The heat spreads directly from the heating unit from an element intermediate in the heating unit and the food pan itself.

A further alternative provides a liquid, a solid or an open space at the bottom of the food pan, which helps evenly spread the heat across the length and the width of the food pan, eliminating, as noted, the water pan.

A removable lining made of aluminum or aluminum material is also usable with the invention, which is placed inside of the food dish or pan and serves the dual functions of also aiding and spreading the heat throughout the entire heat dish and also protects the food pan from soiling.

The food pan may have a bottom wall which either defines a space or contains within itself a heating core that is preinstalled. The heating core may work with high or low voltage, similar to a “hot tray” and its heat can be regulated. The high or low voltage may be house voltage or a portable energy source, such as a rechargeable battery, a generator, or the like.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A heating system for warming food in a chafing dish assembly, the system comprising:
a food tray;
a flameless heating unit including a housing and a grill, wherein the grill and the heating unit are structured to keep any flame produced by the heating unit inside the housing below the grill;
an energy source connected to the heating unit; and
a support effective to support the food tray above the heating unit.

2. The heating system as recited in claim 1, wherein the heating unit is selected from a gas-operable heating unit group including a catalytic converter and a gas burner.

3. The heating system as recited in claim 2, wherein the gas source is connected to the heating unit through a cable.

4. The heating system as recited in claim 3, wherein the cable is effective to convey both gas and electrical signals.

5. The heating system as recited in claim 2, wherein the heating unit comprises a catalytic converter and the heating unit and the gas source are disposed in a single housing.

6. The heating system as recited in claim 2, wherein the heating unit comprises a catalytic converter and the heating unit and the gas source are disposed in two separate housings, including a gas supply housing.

7. The heating system as recited in claim 5, wherein the gas supply housing includes at least one removable gas canister.

8. The heating system as recited in claim 6, wherein the housing includes a door enabling access to the gas canister.

9. The heating system as recited in claim 1, further comprising a cut-off switch disposed on a bottom of the housing.

10. The heating system as recited in claim 6, further comprising an input gas conduit disposed on the housing, the input gas conduit allowing for gas access to the canister.

11. The heating system as recited in claim 5, wherein the single housing comprises an upper chamber supporting the heating unit and a lower chamber supporting the gas source, and wherein the gas source comprises a plurality of gas canisters.

12. The heating system as recited in claim 5, where the cable comprises a gas conduit and the gas source comprises a gas input coupling which allows the gas source to be recharged after use from an external source.

13. A heating system for warming food, the system comprising:
a food tray, the food tray including a housing and a divider, the divider defining a first space where food may be placed and a second space at a bottom portion of the housing beneath the first space;
a heating element; and
a support effective to support the food tray above the heating element.

14. The heating system as recited in claim 13, wherein the second space is filled with a heat distributing material selected from the material group consisting of a gas, a liquid and a solid.

15. The heating system as recited in claim 13, wherein the divider is removably attached to the housing.

16. The heating system as recited in claim 13, further comprising a heating element disposed in the space.

17. A heating system for warming food, the system comprising:
a food tray;
a housing defining at least one channel;
a respective heating element disposed in each of the channels;
a grill disposed above the heating elements and connected to the housing, the grill effective to keep a flame produced by the heating elements inside the housing; and
a support effective to support the food tray above the housing.

18. The heating system as recited in claim 17, wherein the heating elements each comprise STERNO® containers.

19. The heating system as recited in claim 17, wherein each channel further includes a cover, each cover including a respective aperture.

20. The heating system as recited in claim 17, wherein the grill is pivotally connected to the housing.
